(19) United States
(12) Patent Application Publication
(10) Pub. No.: US 2020/0208652 A1
(43) Pub. Date: Jul. 2, 2020

(54) RADIAL COMPRESSOR COMPRISING AN IRIS DIAPHRAGM MECHANISM FOR A CHARGING DEVICE OF AN INTERNAL COMBUSTION ENGINE, CHARGING DEVICE, AND LAMELLA FOR THE IRIS DIAPHRAGM MECHANISM

(71) Applicant: Vitesco Technologies GMBH, Hannover (DE)

(72) Inventors: Mathias Bogner, Straubing (DE); Christoph Schäfer, Coburg (DE); Sasa Slavic, Heidelberg (DE)

(73) Assignee: Vitesco Technologies GMBH, Hannover (DE)

(21) Appl. No.: 16/818,470

(22) Filed: Mar. 13, 2020

Related U.S. Application Data
(63) Continuation of application No. PCT/EP2018/070137, filed on Jul. 25, 2018.

(30) Foreign Application Priority Data
Sep. 14, 2017 (DE) 10 2017 216 329.1

(51) Int. Cl. F04D 29/46; F16K 3/03; F01D 17/14; F04D 17/10; F04D 29/42

(52) U.S. Cl. CPC F04D 29/464; F16K 3/03; F01D 17/141; F05D 2250/51; F04D 29/4213; F05D 2220/40; F04D 17/10

(57) ABSTRACT

A radial compressor comprising an iris diaphragm mechanism for a charging device of an internal combustion engine. The charging device comprises a radial compressor and a lamella for the iris diaphragm mechanism. The radial compressor has an impeller which is rotationally fixed to a rotatably mounted rotor shaft; and a fresh air supply channel for conducting a fresh air mass flow to the impeller. An iris diaphragm mechanism is arranged upstream of the impeller such that a flow cross-section for the fresh air mass flow for admission to the impeller can be variably adjusted at least over a sub-region. The iris diaphragm mechanism comprises several lamellae, wherein each lamella has a lamella base body with an inner edge portion for delimiting the diaphragm aperture, and the inner edge portion of each lamella has an inner edge, which is blunt-edged, on a side facing away from the impeller.

### CROSS-REFERENCE TO RELATED APPLICATIONS

This application claims the benefit of PCT Application PCT/EP2018/070137, filed Jul. 25, 2018, which claims priority to German Application DE 10 2017 216 329.1 filed Sep. 14, 2017. The disclosures of the above applications are incorporated herein by reference.

### TECHNICAL FIELD

The invention relates to a radial compressor comprising an iris diaphragm mechanism for a charging device of an internal combustion engine. Furthermore relating to a charging device having a radial compressor, and to lamellae for the iris diaphragm mechanism of the radial compressor.

### BACKGROUND

Charging devices are increasingly being used to increase power in internal combustion engines, especially in motor vehicle internal combustion engines. More and more frequently, this is done with the aim of reducing the overall size and weight of the internal combustion engine for the same power or even increased power and, at the same time, of reducing fuel consumption and thus CO₂ emissions, in view of ever stricter legal requirements in this respect. The principle consists in increasing the pressure in an intake tract of the internal combustion engine and thus in bringing about better filling of a combustion chamber of the internal combustion engine with atmospheric oxygen. In this way, more fuel, such as gasoline or diesel, can be converted in each combustion process, i.e. the power of the internal combustion engine can be increased.

One specific example of a charging device of this kind is an exhaust gas turbocharger, which uses the energy contained in the exhaust gas flow to produce the pressure in the intake tract. To this end, the exhaust gas turbocharger has an exhaust gas turbine arranged in the exhaust tract of the internal combustion engine, a radial compressor arranged in the intake tract and a rotor bearing arranged in-between. The exhaust gas turbine has a turbine housing and a turbine impeller arranged therein, which is driven by the exhaust gas mass flow. The radial compressor has a compressor housing and a compressor impeller arranged therein, which builds up a boost pressure. The turbine impeller and the compressor impeller are arranged for conjoint rotation on the opposite ends of a common shaft, referred to as the rotor shaft, and thus form what is referred to as the turbocharger rotor.

The rotor shaft extends axially between the turbine impeller and compressor impeller through the rotor bearing arranged between the exhaust gas turbine and radial compressor, and is rotatably mounted in said rotor bearing in the radial and axial directions in relation to the rotor shaft axis. According to this construction, the turbine impeller driven by the exhaust gas mass flow drives the compressor impeller via the rotor shaft, thereby increasing the pressure in the intake tract of the internal combustion engine behind the radial compressor in relation to the air mass flow, and thereby ensuring better filling of the combustion chamber with atmospheric oxygen.

As an alternative, it is also possible, in a charging device of this kind, to use an electric motor drive unit for example to drive the radial compressor instead of an exhaust gas turbine. A charging device of this kind is also referred to as an “E booster” or “E charger”.

The operating behavior of the radial compressor is characterized by a “compressor map”, which describes the pressure buildup against mass flow for various compressor rotational speeds or peripheral speeds. A stable and usable characteristic map of the radial compressor is bounded by the “surge limit” toward low flow rates, by the “choke limit” toward higher flow rates, and by the maximum rotational speed limit in respect of structural mechanics.

In adapting an exhaust gas turbocharger to an internal combustion engine, a radial compressor is selected which has a compressor characteristic map which is as expedient as possible for the internal combustion engine. The following preconditions should be satisfied here: an engine full-load curve is to be completely within the usable compressor characteristic map; minimum clearances with respect to the characteristic map limits, as required by the vehicle manufacturer, are to be maintained; maximum compressor efficiencies are to be available at the rated load and in a range of a lower low-end torque of the internal combustion engine; and the compressor wheel is to have a minimum moment of inertia.

Satisfying all the preconditions mentioned would be possible only to a limited extent with a conventional radial compressor without additional measures. For example, the following conflicting aims would arise from opposing trends: reduction in the moment of inertia of the radial compressor and maximization of the characteristic map width and of the peak efficiency; reduction of scavenging in the region of the lower low-end torque and maximization of the specific rated power; improvement of the response and increase in the specific rated power of the internal combustion engine.

The stated aims could be resolved by a compressor design which has a wide characteristic map with a minimum moment of inertia and maximum efficiencies on the full-load curve of the engine.

Apart from the steady-state requirements mentioned, stable operating behavior of the compressor must also be ensured in transient operating states, for example in the case of rapid load shedding by the internal combustion engine. This means that, in the case of a radial compressor, the damaging “compressor surge” must be avoided in the case of a sudden decrease in the compressor mass flow delivered.

While being restricted to the compressor inlet of a radial compressor, the abovementioned solution has hitherto been achieved by additional measures, such as adjustable inlet guide vanes, measures for reducing an inlet cross-section of the radial compressor or a fixed recirculation channel, also referred to as a ported shroud or map-stabilizing measure. In the case of the variable solutions, the widening of the useful working range of the radial compressor is achieved by actively shifting the characteristic map. In the case of engine operation at low speeds and flow rates, for example, the compressor map is shifted “to the left”, toward low mass flows, while, in engine operation at high speeds and flow rates, the compressor map is not shifted or is shifted “to the right”, toward higher mass flows.

Through the setting of vane angles and the induction of a pre-swirl in or counter to the direction of rotation of the compressor impeller, the inlet guide vane assembly shifts the entire compressor map toward relatively low or relatively high throughputs. The required adjusting mechanism and the inlet guide vanes themselves represent a complex solution, however.

The compressor map is shifted towards relatively low throughputs by the measures involving constriction of the compressor inlet by cross-section reduction, in that the inlet cross-section is reduced by closing the structure immediately in front of the compressor. In the open state, these measures again expose the entire inlet cross-section again as far as possible and hence do not or only marginally influence or shift the map.

To avoid compressor surge in the case of rapid load shedding, a “blowoff valve” is usually used; said valve opens a bypass from the compressor outlet to the compressor inlet in the case of a sudden decrease in the charge air mass flow through the internal combustion engine, and thus keeps the radial compressor in the stable map range to the right of the surge limit. A combination of active measures, such as variable inlet guide vanes and blowoff valve, is conceivable but unusual.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A radial compressor for a charging device of an internal combustion engine which leads to reliable operation of the charging device with a simultaneously extended characteristic map range is provided. Moreover, a lamella for an iris diaphragm mechanism of the radial compressor which makes possible the abovementioned concept for the radial compressor. A charging device is provided for an internal combustion engine by which the radial compressor can be implemented during the operation of the internal combustion engine.

A radial compressor for a charging device of an internal combustion engine is disclosed. The radial compressor furthermore has a compressor impeller, which is arranged in a compressor housing and is rotationally fixed to a rotatably mounted rotor shaft. The radial compressor furthermore has an air supply channel, which is designed to conduct an air mass flow to the compressor impeller.

An iris diaphragm mechanism is arranged upstream of the compressor impeller and is designed to at least partially close or to open a diaphragm aperture, thus allowing variable adjustment of a flow cross-section for the air mass flow, e.g. a cross-section of the air supply channel, for admission to the compressor impeller, at least over a partial region. The iris diaphragm mechanism comprises several lamellae, wherein each lamella has a lamella base body which has an inner edge portion for delimiting the diaphragm opening. The inner edge portion of each lamella has an inner edge, which is not sharp-edged, i.e. blunt, on the side facing away from the compressor impeller.

In one exemplary embodiment of the radial compressor, a variable iris diaphragm mechanism is provided, which is typically arranged in the air supply channel directly upstream of the compressor inlet for the purpose of shifting the characteristic map. The iris diaphragm mechanism can also be referred to as an iris diaphragm or iris restrictor and has the task of adjusting the inlet mass flow of the radial compressor, at least over a partial region. In this case, the iris restrictor acts like a kind of mask for an outer region of the compressor inlet. As restriction increases, i.e. as the cross-section is narrowed, the iris restrictor as it were takes on the function of a blowoff valve since it can prevent compressor surge of the radial compressor. This makes it possible to actively influence the operating range of the radial compressor and, in addition, to keep the radial compressor at a stable operating point in the event of sudden load shedding by the engine.

The air supply channel is formed on the radial compressor. For example, the air supply channel is formed at least partially by the compressor housing, the iris diaphragm mechanism, an intake connector and/or other components of the radial compressor.

In one exemplary embodiment, the iris diaphragm mechanism has a plurality of lamellae which can be moved relative to one another by rotation and which are arranged in partial overlap with one another over the circumference of the air supply channel, concentrically with the center line of the air supply channel or compressor inlet. Each lamella is mounted on a fixed bearing part so as to be rotatable about a respective pivot point, preferably arranged in an edge region of the lamella, and is operatively connected to an actuating element, which is preferably arranged in a lamella edge region opposite the pivot point, by means of a movably mounted adjusting ring.

The bearing part is, for example, a bearing ring fixed in the region of the air supply channel, a separate housing of the iris diaphragm mechanism, part of the compressor housing of the turbocharger or formed in several parts, e.g. by part of the compressor housing and a separate additional housing part. In this case, the bearing part is of ring-shaped design or has a ring-shaped section. The bearing part can also be a fixed housing element.

In this exemplary embodiment, the adjusting ring is arranged concentrically with the bearing part and can be rotated around the common center line, which simultaneously forms the center line of the air supply channel or compressor inlet. The lamellae are synchronized and moved jointly via the adjusting ring. The rotation of the adjusting ring about its central axis also initiates, by means of the actuating element, the rotation of the lamellae about their respective pivot points. When the lamellae are rotated parallel to the axis of rotation of the compressor impeller, the lamellae pivot radially inward and thus lead to a desired narrowing of the flow cross-section directly ahead of the compressor wheel. The adjusting ring itself is controlled and moved by means of an actuator, for example. The actuator can be an electrically or pneumatically operated adjuster.

Each lamella has a substantially plate-like, flat lamella base body, which is used to screen the air mass flow and thus adjust the diaphragm aperture. Here, the lamella base body extends, for example, in a principal plane of extent in the form of a circular ring segment over part of a circular arc, with the ring width and wall thickness remaining the same or varying over the circular arc. Furthermore, each lamella or lamella base body has an inner edge portion which delimits the diaphragm aperture of the iris diaphragm in operation.

The iris diaphragm mechanism must have sufficient strength and robustness to be able to withstand, substantially without deformation, the inflowing air drawn in by the compressor in proper operation of the turbocharger. For this, the lamellae are made so thick, i.e. with such a large wall thickness, that they cannot bend during operation of the turbocharger and thus have adequate stiffness. With respect to an embodiment which is aerodynamically supportive, it is provided that on their upstream side, i.e. on the side of their respective inner edge portion facing away from the compressor impeller or compressor inlet, the lamellae have an inner edge which is not sharp-edged, i.e. blunt. In this way, the flow passes around the inner edge portion of the lamellae in an efficient aerodynamic fashion and hence is admitted to the compressor impeller with low loss. Thus, the through-flow of the iris diaphragm is also improved. In addition, such a design of the inner edge has an effect on sound development in the flow around the inner edge portion of the respective lamella.

In one embodiment, a design which is not sharp-edged, i.e. blunt means that a respective transition between the boundary faces delimiting the inner edge portion of a respective lamella and forming the respective inner edge has an angle which is greater than 90° (measured on the inside of the lamella).

In order to achieve this, the respective inner edge may have a rounding, in particular a radius; a chamfer; a succession of chamfers, i.e. a series of several chamfers in direct succession, or similar.

In comparison with lamellae with sharp edges on the side of the inner edge portion facing the flow, there is no or only little flow separation and hence associated flow turbulence at this point, i.e. directly at the diaphragm inlet, which would be associated with losses and hence reduction in performance of the system. At the same time, this reduces or prevents the so-called “vena contracta” effect. This states that flow separations, such as occur at sharp edges, reduce the effective flow cross-section of a diaphragm relative to the structural diaphragm cross-section. In this way, the actual mass flow through the iris diaphragm, with otherwise equivalent conditions, would be lower than a theoretical mass flow calculated on the basis of the geometric area of the diaphragm aperture.

In principle, the map shift by means of the iris diaphragm mechanism is based on a choking of the compressor. Accordingly, the map shift increases with a smaller diaphragm aperture. The more the diaphragm aperture is closed, the further the map can be shifted. Because of the smaller effective flow cross-section, the map shift is amplified by the vena contracta effect. Consequently, it would be expected that eliminating this effect by the described formation of the inner edge would lead not only to the desired reduction in performance losses but also to a reduction in the map shift.

It has however been found that, as well as the reduction in losses, no or few effects could be found on the map shift despite the fact that the vena contracta effect is no longer or almost no longer present. Thus the performance of the system increases because of the eliminated flow separation, without adverse effects on the desired shift in compressor map. Accordingly, as a whole, the compressor efficiency is increased in the map range obtained by the map shift.

An improvement is achieved in the acoustic behavior of the system, such as with respect to the audible and/or perceptible vibrations in motor vehicles (NVH: noise, vibration, harshness), since turbulence and recirculation areas typically resulting from flow separation induce pressure fluctuations and would hence constitute a sound source. By designing the inner edge of the lamella facing the flow without a sharp edge as described, such eddying, turbulence and recirculation are suppressed so that, accordingly, a noise source is eliminated and the acoustic behavior of the system is improved.

According to one embodiment, the inner edge arranged on the side of the lamella facing away from the compressor impeller has a rounding or is formed by a rounding. In other words, a continuous transition is provided. In particular, the rounding may be formed by a radius. In particular, a particularly positive effect could be achieved from a radius size of 0.5 mm. Furthermore proved useful if the wall thickness of the lamella or lamella base body is at least as large as the selected radius of the mounting. Furthermore, radius sizes and corresponding minimal wall thicknesses of the lamellae of 0.75 mm, 1.0 mm, 1.25 mm, 1.5 mm, 2.0 mm or even more have proved suitable. Optionally, two or more different radii may also be provided along the course of the edge. Alternatively or additionally, the radius may not be constant, e.g. may have a change of curvature.

According to one embodiment, the inner edge arranged on the side facing away from the compressor impeller has a chamfer or is formed by a chamfer. A chamfer is a sloping surface at the edge which forms the transition between two main boundary faces of the corresponding body. The chamfer thus “breaks” a sharp inner edge of the lamella base body. For example, the chamfer is a 45° chamfer, wherein this is the angle by which the chamfer face slopes relative to the course of the respective main boundary face. If the two main boundary faces stand perpendicular to each other, so as to enclose an angle of 90°, the chamfer face of a 45° chamfer slopes by 45° to each adjacent main boundary face.

Alternatively, the side of the inner edge of the lamella base body facing away from the compressor impeller may also be formed by a succession of chamfers. This means a polygonal form or a succession of several chamfers arranged at angles to each other.

The formation as a chamfer or succession of chamfers substantially allows the same functions as cited initially. In this embodiment too, the thickness data given above for the lamella or lamella base body applies. In addition, such a chamfer or succession of chamfers can easily be produced.

According to one embodiment, a thickness of the lamella base body, i.e. its wall thickness, is greater than a wall thickness necessary in structural-mechanical terms for operation of the turbocharger. In other words, the lamellae are configured thicker than necessary for operation of the turbocharger. As stated initially, the lamellae must have sufficient stiffness and hence thickness or wall thickness to prevent failure in operation of the turbocharger. For example, the wall thickness of the lamellae may be selected depending on a desired radius of a rounding of the inner edge which is greater than a wall thickness necessary in structural-mechanical terms. Because the wall thickness of the lamellae is selected greater than a necessary wall thickness, the rounding, chamfer or succession of chamfers may also be formed larger on the inner edge. In other words, a larger radius or chamfer extending over a larger area relative to the axial direction of the radial compressor, predefined by the rotational axis of the compressor impeller, may be provided.

According to one embodiment, each lamella is produced by punching, nibbling, forging, embossing or a casting process. Such processes are particularly advantageous production methods for the lamellae. Such processes create the aerodynamically favorable shape of the side of the lamellae pointing upstream without a second machining cut, and are therefore particularly economic. Other production technologies, in which the lamellae can be produced in one machining step without a subsequent second step, are also suitable.

In this context, a production method for a lamella for an iris diaphragm mechanism is also disclosed. The method is distinguished in that the lamella base body, including the flattening such as a radius, is produced from a semi-finished lamella in one machining process step, such as the above-mentioned punching.

Furthermore, a lamella is disclosed for an iris diaphragm mechanism of a radial compressor as described above. The lamella has a lamella base body which comprises an inner edge portion for delimiting a diaphragm aperture of the iris diaphragm mechanism. The inner edge portion has an inner edge, which is not sharp-edged, on the side facing away from the compressor impeller of the radial compressor, when mounted suitably for operation.

The lamella may advantageously be used in a radial compressor as described above.

The charging device according for an internal combustion engine comprises a radial compressor as described above. The charging device may be configured either as an exhaust gas turbocharger in which the compressor impeller of the radial compressor is driven by means of an exhaust gas turbine arranged in the exhaust gas flow from the internal combustion engine, or as a charger powered by an electric motor, wherein the compressor impeller of the radial compressor is driven by means of an electro-mechanical drive, in particular an electric motor.

As an alternative to the above-mentioned embodiments, the charging device may furthermore also be designed as a charger operated via a mechanical coupling to the internal combustion engine. Such a coupling between the internal combustion engine and the radial compressor can be accomplished by means of an intermediate gear mechanism for example, which is operatively connected to a rotating shaft of the internal combustion engine on the one side, and to the rotor shaft of the radial compressor on the other.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a schematic sectional view of a charging device with a radial compressor according to the invention,

FIGS. 2A to 2C show schematically simplified depictions of an exemplary embodiment of an iris diaphragm mechanism in top view from the axial direction, in three different operating states,

FIG. 3 shows a perspective view of an embodiment of a lamella according to the invention of an iris diaphragm mechanism,

FIG. 4 shows a schematically simplified sectional view of one embodiment of a radial compressor with an iris diaphragm mechanism,

FIG. 5 shows a schematic detail view of the inner edge portion of a lamella of the iris diaphragm mechanism of the radial compressor in FIG. 4, according to the prior art,

FIG. 6 shows a further schematic detail view of the inner edge portion of a lamella of the iris diaphragm mechanism of the radial compressor according to an exemplary embodiment of the invention,

FIG. 7 shows a further schematic detail view of the inner edge portion of a lamella of the iris diaphragm mechanism of the radial compressor according to a further exemplary embodiment of the invention, and

FIG. 8 shows a schematic, partial sectional view of a lamella according to the invention of the iris diaphragm mechanism from FIG. 6, with punching tool, in a production step in production of the lamella.

### DETAILED DESCRIPTION

The exemplary embodiments will be described below with the aid of the appended figures. Elements that are of identical type or act identically are provided with the same reference signs throughout the figures.

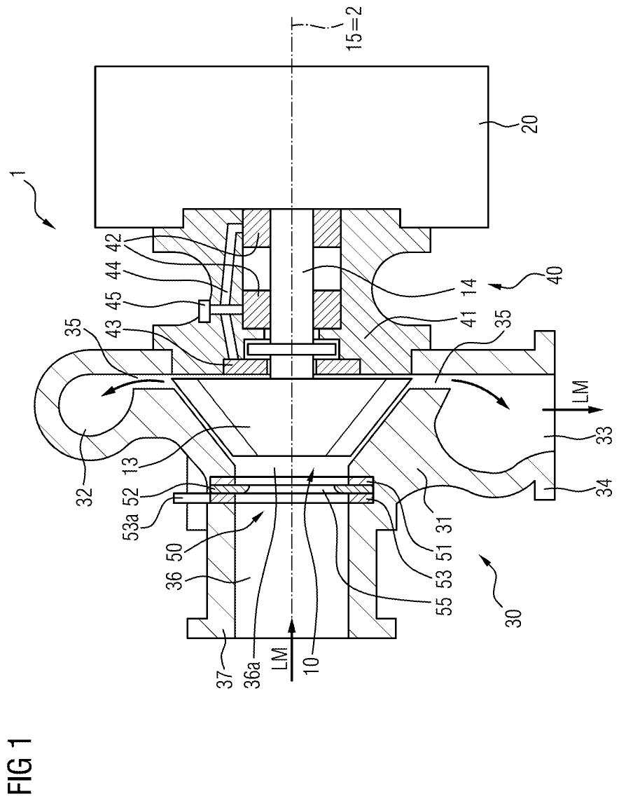

FIG. 1 shows an embodiment of a charging device 1 according to the invention. The charging device 1 has an embodiment of a radial compressor 30 according to the invention, a rotor bearing 40 and a drive unit 20. The radial compressor has a compressor impeller 13, which is arranged in a compressor housing 31 and comprises impeller blades 131. The compressor impeller 13 is rotationally fixed to a rotor shaft 14 that is rotatably mounted in a bearing housing 41 of the rotor bearing 40 and forms the so-called charger rotor 10.

The charger rotor 10 rotates about a rotor axis of rotation 15 of the rotor shaft 14 during operation. The rotor axis of rotation 15 simultaneously forms the charger axis 2 or compressor axis (which can also simply be referred to jointly as the longitudinal axis of the charging device), is formed by the center line depicted and indicates the axial orientation of the charging device 1. The rotor shaft 14 of the charger rotor 10 is mounted by means of two radial bearings 42 and an axial bearing disk 43 in a bearing housing 41, which together form an embodiment of the rotor bearing 40. Here, both the radial bearings 42 and the axial bearing disk 43 are supplied with lubricant via oil supply channels 44 of an oil connection 45.

According to the exemplary embodiment shown, a charging device 1 of the kind illustrated in FIG. 1 has a multi-part construction. Here, a housing of the drive unit 20, a compressor housing 31 that can be arranged in the intake tract of the internal combustion engine, and a rotor bearing 401 provided between the turbine housing 20 and compressor housing 31, are arranged adjacent to one another with respect to the common charger axis 2 and connected together in terms of assembly. In this case, alternative arrangements and configurations of the drive unit 20 and the bearing assembly 40 are also quite possible. A further structural unit of the charging device 1 is represented by the charger rotor 10, which has at least the rotor shaft 14 and the compressor impeller 13, which is arranged in the compressor housing 31.

The radial compressor 30 furthermore has an air supply channel 36, which adjoins the compressor housing 31 and forms the compressor inlet 36a, for carrying an air mass flow LM to the compressor impeller 13, said channel having an intake pipe connection stub 37 for connection to the air intake system (not illustrated) of the internal combustion engine and extending in the direction of the charger axis 2 toward the axial end of the compressor impeller 13. Via this air supply channel 36, the air mass flow LM is drawn in from the air intake system by the compressor impeller 13 and conducted to the compressor impeller 13.

The air supply channel 36 can also be part of an intake stub and thus not part of the compressor housing 31, but adjoins the compressor inlet 36a formed on the compressor housing 31, for example. In this arrangement, the iris diaphragm mechanism 50 is fixed in the air supply channel 36 and/or forms a partial region of the air supply channel 36 directly ahead of the compressor inlet 36a of the compressor housing 31.

Furthermore, the compressor housing 31 generally has a spiral channel 32 which is arranged in a ring around the charger axis 2 and the compressor impeller 13, and which widens spirally away from the compressor impeller 13, and which is referred to as a compressor flute. Said spiral channel 32 has a gap opening which runs at least over a part of the inner circumference and which has a defined gap width, and is referred to as a diffuser 35, which is directed in a radial direction away from the outer circumference of the compressor impeller 13, said diffuser runs into the spiral channel 32.

The air mass flow LM flows through said diffuser away from the compressor impeller 13 at elevated pressure into the spiral channel 32. Here, therefore, the spiral channel 32 serves to receive and discharge the compressed air mass flow LM flowing away from the compressor impeller 13 and exiting through the diffuser 35. The spiral channel 32 furthermore has a tangentially outwardly directed air discharge channel 33 with a manifold connection stub 34 for connection to an air manifold (not illustrated) of an internal combustion engine. Through the air discharge channel 33, the air mass flow LM is conducted at elevated pressure into the air manifold of the internal combustion engine.

In FIG. 1, the drive unit 20 is not shown in detail and can be embodied either as an exhaust gas turbine or as an electric motor drive unit, or as a mechanical coupling to the internal combustion engine e.g. as an intermediate gear mechanism that is operatively connected to a rotating shaft of the internal combustion engine, making the charging device 1 into either an exhaust gas turbocharger in one case, or in the other case into an electric motor powered charger, also referred to as an E booster or E compressor, or into a mechanical charger. In the case of an exhaust gas turbocharger, a turbine impeller would be provided opposite the compressor impeller 13, for example, and said impeller would likewise be arranged for conjoint rotation on the rotor shaft 14 and be driven by an exhaust gas mass flow.

Upstream of the compressor impeller 13 in the air mass flow LM, the iris diaphragm mechanism 50 is arranged in the air supply channel 36 in addition to or as an alternative to a blowoff valve, directly ahead of a compressor inlet 36a (also compressor entry), and/or forms at least one partial region of the air supply channel 36 directly ahead of the compressor inlet 36a of the compressor housing 31, and hence in the immediate vicinity of the inlet edges 132 of the impeller blades 131.

The iris diaphragm mechanism 50 is designed to at least partially close or open a diaphragm aperture 55 such that a flow cross-section for the air mass flow LM, for admission into the compressor impeller 13, can be set variably at least over a sub-region of the flow cross-section. In this way, the iris diaphragm mechanism 50 allows shifting of the characteristic map for the radial compressor 30 since it acts as a variable inlet restrictor for the compressor impeller 13.

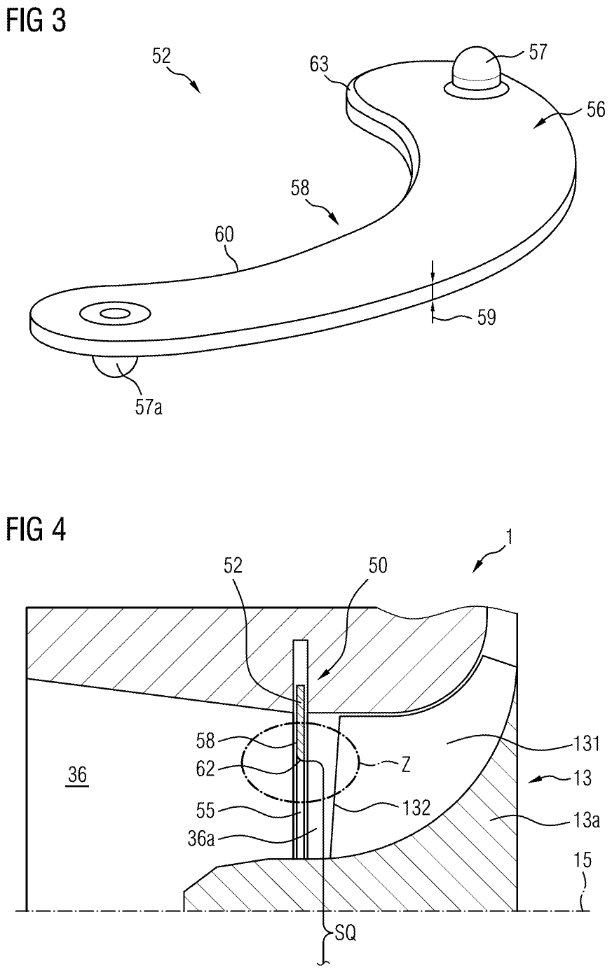

The iris diaphragm mechanism 50 has, for example, a bearing ring 51 fixed in the air supply channel 36 concentrically with the compressor inlet 36a; an adjusting ring 53, which is arranged concentrically therewith, can be rotated about a common center and has an adjusting lever 53a; and a plurality of lamellae 52 mounted so as to be rotatable about a respective pivot point in the bearing ring 51. As shown for example in an exemplary embodiment in FIG. 3, the lamellae 52 each have a plate-shaped lamella base body 56 and a pin-shaped or peg-like actuating element 57 (not visible here), which is designed for the actuation of the respective lamella 52, and a bearing element 57a (also pin-shaped or peg-like) for the rotatable mounting of the respective lamella 52 on said bearing ring 51, as integral components of the respective lamella 52.

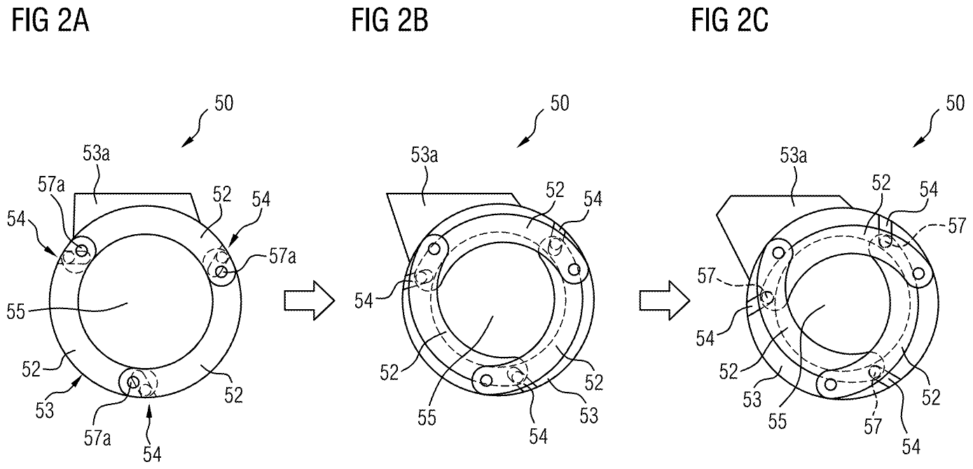

FIGS. 2a to 2c show schematically one embodiment of an iris diaphragm mechanism 50 for a radial compressor 30 according to the invention in three different operating states. The iris diaphragm mechanism 50 has a stationary, fixed (fixed location) bearing ring 51 (not illustrated here so that the lamellae are visible). As illustrated in FIG. 1, the bearing ring 51 can be formed by a separate component which is fixed in the surrounding housing, e.g. the air supply channel 36. As an alternative, the bearing ring 51 can also be formed directly in the surrounding housing and integrally with the latter. Thus, the bearing ring 51 can also be formed directly on the compressor inlet 36a of the compressor housing 31.

As an alternative, it is also possible for a separate housing to be provided for the iris diaphragm mechanism 50, and therefore the iris diaphragm mechanism 50 can be mounted as a separate pre-assembled functional unit on the compressor housing 31 or in the air supply channel 36.

In this example, three lamellae 52 are mounted on the bearing ring 51 so as to be rotatable about a respective bearing element 57a (only marked in FIG. 2A). For this purpose, the bearing ring 51 has an associated rotary bearing location for each lamella 52, at which location the respective lamella 52 is rotatably mounted by means of its bearing element 57a.

Each lamella 52 has an actuating element 57 (shown only in dotted lines in FIGS. 2a, 2b and 3c, and only marked in FIG. 2C) for actuation by an adjusting ring 53, wherein the bearing element 57a is arranged in an end region of the respective lamella 52 situated opposite the actuating element 57.

A pin-shaped or peg-like element, by means of which the respective lamella 52 is mounted in a hole or recess provided in the bearing ring 51 and forming the bearing location, can be provided as a bearing element 57a on the respective lamella 52, for example.

The iris diaphragm mechanism 50 furthermore has an adjusting ring 53, which is arranged concentrically with the bearing ring 51 and can be rotated about a common center, said adjusting ring being concealed by the lamellae 52 in FIG. 2A and being visible only by its adjusting lever 53a. In the example in FIGS. 2A to 2C the adjusting ring 53 has three grooves 54 (only shown indicatively in dotted lines in FIGS. 2A to 2C, since largely concealed by the lamellae) for guided actuation of the lamellae 52. In this case, for each lamella 52, a groove 54 is provided which extends obliquely in relation to the radial direction of the adjusting ring 53, and in which the actuating element 57 of the respective lamella 52 engages and is guided. In this way, the lamellae 52 are moved in synchrony by rotation of the adjusting ring 53. The adjusting ring 53 is mounted at its outer circumference, for example, on or in the housing of the iris diaphragm mechanism 50, or in a housing part formed for this purpose in the compressor housing 31 or the air supply channel 36.

By actuation of the adjusting ring 53, i.e. by rotation about the center shared with the bearing ring 51, the actuating elements 57 of the lamellae 52 are guided radially inward by the obliquely extending grooves 54 and, in this way, the lamellae 52 are likewise pivoted radially inward about the respective bearing location and thus constrict a diaphragm aperture 55 of the iris diaphragm mechanism 50.

FIG. 2A shows the diaphragm aperture 55 with a maximum opening width, FIG. 2B shows the diaphragm aperture with a reduced opening width, and FIG. 2C shows the diaphragm aperture 55 with a minimum opening width. These illustrations thus show the partial region of the flow cross-section for this exemplary embodiment which can be adjusted variably by partial closure or opening of the iris diaphragm mechanism 50. The iris diaphragm mechanism 50 thus acts as a variable inlet restrictor and, in this way, as mentioned at the outset, allows shifting of the characteristic map for the radial compressor 30.

FIG. 3 shows a perspective view of an embodiment of a lamella 52 according which is mounted for example in the iris diaphragm mechanism 50 described with reference to FIGS. 2A to 2C. The lamella 52 is a substantially flat, plate-like element. The lamella 52 thus has a plate-like lamella base body 56 which is formed arcuate according to FIG. 3.

The lamella base body 56 essentially constitutes the element which is responsible for choking the compressor impeller 12. The lamella 52 has, in each of its opposing end regions, an actuating element 57 and a bearing element 57a which are formed on opposite sides of the lamella 52 in order to cooperate with the adjusting ring 53 or bearing ring 51 respectively. The lamella 52 has an inner edge portion 58 which, when the lamella is in the correctly mounted state in the iris diaphragm mechanism of the radial compressor, delimits the diaphragm aperture 55 (see FIGS. 2B and 2C).

The lamella base body 56 has a wall thickness 59 (also known as thickness) which is configured or dimensioned so as to give adequate stiffness for use in the iris diaphragm mechanism 50 of the radial compressor 30, and to prevent bending under normal operating conditions. The inner edge 60 formed on the inner edge portion 58 is also visible; this is not sharp-edged and in this exemplary embodiment has a chamfer 63 for flow guidance.

FIG. 4 shows a simplified, schematic, partial sectional view of the radial compressor 30 in the region of the compressor inlet 36a. The outer contour of the compressor impeller 13 with its wheel hub 13a and impeller blades 131 is shown in a meridional section. The drawing shows an inlet edge 132 of the impeller blades which are arranged in the direct vicinity of the compressor inlet 36a. The iris diaphragm mechanism 50, here reduced to the lamella arrangement, is here also shown in schematic, simplified sectional view. The iris diaphragm mechanism 50 is here arranged in the air supply channel 36 directly before, i.e. upstream of the compressor inlet 36a. The inner edge portions 58 of the lamellae 52 limit the diaphragm aperture 55 to a flow cross-section SQ. The inner edge 60 of the lamellae is here configured with a rounding 62, in particular a radius, on the side facing away from the compressor impeller 13, i.e. on the side lying upstream in the air mass flow.

FIG. 5 shows an enlarged detail view Z of the inner edge 60 of the lamella 52, largely in accordance with FIG. 4 but—in contrast to the object of the invention—with a sharp-edged form of the inner edge 60. Each lamella 52 has an inner edge portion 58 with an inner edge 60 facing away from the compressor impeller 13.

In the embodiment in FIG. 5, the inner edge 60 is formed with a sharp edge, leading to disruptive flow separation, recirculation and turbulence 61 (indicated by the exemplary flow arrows of the air mass flow LM). Such flow separation, recirculation and turbulence 61 cause losses and adversely affect the performance of the system. Also, for a specific diaphragm aperture 55, the structural flow cross-section SQ is reduced to an effective flow cross-section SQeff of the diaphragm, wherein this phenomenon is known as the vena contracta effect as stated initially.

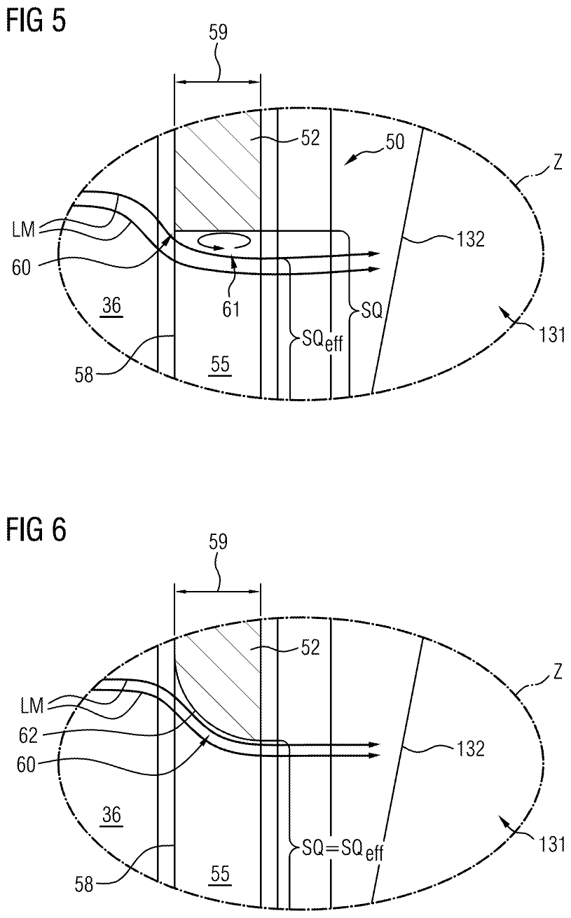

FIG. 6 shows an enlarged detail view Z of the inner edge 60 of a lamella 52 as in FIG. 4, according to an exemplary embodiment. In contrast to the embodiment in FIG. 5 described above, the inner edges 60 of the lamellae 52, lying on the side of the lamellae 52 facing away from the compressor impeller 13, are formed without sharp edges and have a rounding 62 in the form of a radius.

Such a radius on the inner edge of the lamella has for example a size in the region of the wall thickness 59 of the lamella 52, or less than the wall thickness. In various examples, the wall thickness 59 of the lamella 52 lies in a range from 0.5 mm to 2 mm. If the radius of the rounding 62 is equal to or less than the respective wall thickness 59 of the lamella 52, the air flow LM is no longer deflected into a direction parallel to the charger axis 2 at the inner edge of the lamella 52 facing the compressor impeller 13, and there is no further constriction of the flow cross-section SQ downstream of the diaphragm aperture 55, so that the effective flow cross-section SQeff corresponds to the flow cross-section SQ given by the diaphragm aperture 55.

Since however it has proved further supportive to dimension the rounding, in particular a radius, as large as possible in order to prevent premature stalling of the air flow, the wall thickness 59 of the lamella 52 may be selected to be greater than would be necessary in structural-mechanical terms for the necessary stability.

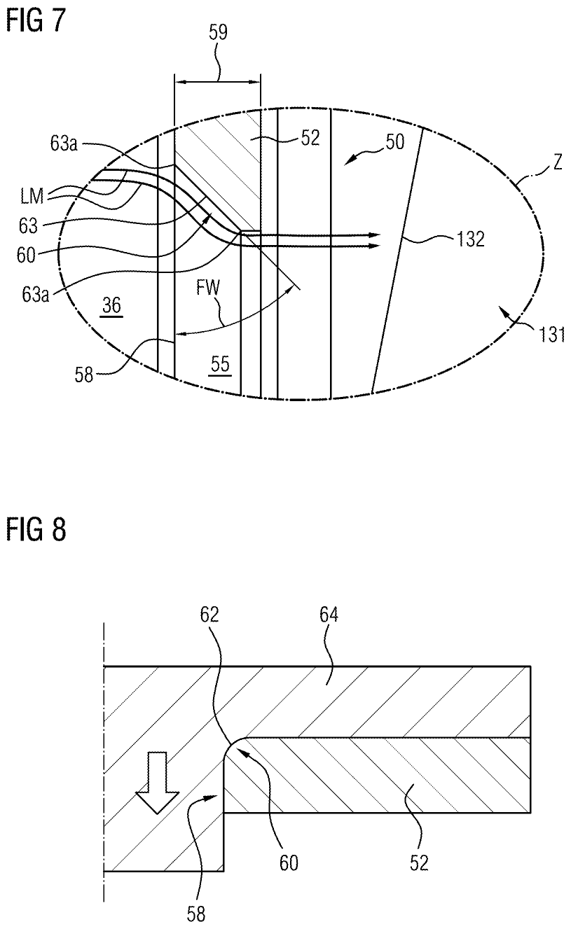

FIG. 7 shows a further enlarged detail view Z of the inner edge 60 of a lamella 52, largely as in FIG. 4, according to a further exemplary embodiment. In contrast to the embodiment in FIG. 6 described above, the inner edges 60 of the lamellae 52, lying on the side of the lamellae 52 facing away from the compressor impeller 13, are formed as a chamfer 63 with a chamfer angle FW. The chamfer angle FW refers here to the deviation of the chamfer from the principal plane of extent of the lamella 52 or lamella base body 56, standing perpendicularly to the charger axis 2.

By provision of a chamfer 63, two surface transitions are produced, each forming a chamfer edge 63a. In order to avoid flow separation, the chamfer edges 63a should each define a direction change of the air mass flow which is as gentle as possible. If the transition angle of a chamfer edge 63a is reduced, as a result at the same time the transition angle of the respective other chamfer edge 63a is increased, and hence the tendency to flow separation is also increased at this point. Thus, the chamfer angle FW may be selected to be in the region of 45°, since this achieves a common minimum of transition angles of chamfer edges 63a.

The chamfer 63 should be dimensioned such that it does not extend over the entire wall thickness 59 of the lamella, so that at the inner edge portion 58 of the lamella 52, an edge remains which extends in the direction of the charger axis 2, i.e. the main flow direction of the air mass flow LM, and which can carry the air mass flow LM.

By The chamfer 63 may be dimensioned as large as possible in order to calm the air flow and thus prevent premature stalling, and may again be possible to select the wall thickness of the lamella 52 greater than would be necessary in structural-mechanical terms for the necessary stability.

Thus, the functions cited initially are also achieved by arrangement of a chamfer.

In further exemplary embodiments (not shown), instead of a single chamfer, a succession of chamfers is formed, i.e. a polygonal line. Several chamfer portions with different chamfer angles FW are thus arranged successively. In this way, the transition angles of the individual chamfer edges may be selected smaller. This allows a gentler direction change of the air mass flow and thus helps avoid premature stalling.

FIG. 8 shows a schematic, detail sectional view of a lamella 52 according to the invention of the iris diaphragm mechanism 50 from FIG. 6, with punching tool 64, in a production step in production of the lamella. In order to produce a corresponding inner edge 60 which is not sharp-edged, for example as here in the form of a radius 62, a punching tool 64 with corresponding negative form is used for shaping. The lamella base body of the lamella 52 may thus be produced with the aerodynamically supportive inner edge 60, which does not have a sharp edge, particularly economically in one machining step, without further machining steps being required. For this, the lamella 52 is punched out of a flat semi-finished product in one working step by means of the punching tool 64, and the corresponding inner edge is formed at the same time so that the respective inner edge 60 is not sharp-edged.

Alternatively, as cited initially, other production processes are conceivable which allow the definitive form of the lamella base body 56 to be produced in one machining step.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A radial compressor for a charging device of an internal combustion engine comprising:
an impeller arranged in a compressor housing and rotationally fixed to a rotatably mounted rotor shaft;
a fresh air supply channel for carrying a fresh air mass flow to the impeller;
an iris diaphragm mechanism upstream of the impeller to at least partially close or to open a diaphragm aperture thus allowing variable adjustment of a flow cross-section for the fresh air mass flow for admission to the impeller at least over a partial region; and
a plurality of lamellae each having a lamella base body with an inner edge portion for delimiting the diaphragm aperture, wherein the inner edge portion an inner edge, which is blunt-edged on a side facing away from the impeller.

2. The radial compressor as claimed in claim 1, wherein the side of the inner edge facing away from the impeller has a rounding.

3. The radial compressor as claimed in claim 2, wherein the rounding is formed by a radius which is greater than or equal to 0.5 mm.

4. The radial compressor as claimed in claim 1, wherein the side of the inner edge facing away from the impeller has a chamfer.

5. The turbocharger as claimed in claim 1, wherein the side of the inner edge facing away from the impeller is formed by a succession of chamfers.

6. The radial compressor as claimed in claim 1, wherein a wall thickness of the lamella base body is greater than a wall thickness necessary for operation of the radial compressor.

7. The radial compressor as claimed in claim 1, wherein each lamella is produced by one of: punching, nibbling, forging, embossing and a casting process.

8. The radial compressor as claimed in claim 1, wherein the lamella has a lamella base body which has an inner edge portion for delimiting a diaphragm aperture of the iris diaphragm mechanism.

8. The radial compressor as claimed in claim 1, wherein the inner edge portion has an inner edge, which is blunt-edged, on a side facing away from a compressor wheel of the turbocharger, when mounted suitably for operation.

9. The radial compressor as claimed in claim 1, wherein the radial compressor is located in a supercharging device which is one of: an exhaust-gas turbocharger, a supercharger operated by electric motor, and as a supercharger operated via a mechanical coupling to the internal combustion engine.
